(19) United States
(12) Patent Application Publication
(10) Pub. No.: US 2007/0019805 A1
(43) Pub. Date: Jan. 25, 2007

(54) System employing systematic robust error detection coding to protect system element against errors with unknown probability distributions

(75) Inventors: Mark Karpovsky, Newton, MA (US); Alexander Taubin, Brookline, MA (US); Konrad Kulikowski, Columbia, CT (US)

Correspondence Address: DAVID E. HUANG, ESQ.;BAINWOOD HUANG & ASSOCIATES LLC, 2 CONNECTOR ROAD, SUITE 2A, WESTBOROUGH, MA, 01581, US

(73) Assignee: Trustees of Boston University, Boston, MA (US)

(21) Appl. No.: 11/476,421

(22) Filed: Jun. 28, 2006

Related U.S. Application Data
(60) Provisional application No. 60/694,606, filed on Jun. 28, 2005.
(60) Provisional application No. 60/694,607, filed on Jun. 28, 2005.

(51) Int. Cl. H04L 9/28

(52) U.S. Cl. 380/28

(57) ABSTRACT

An error detection technique can be used with data encryption/decryption such as those implementing the Advanced Encryption Standard (AES) to protect against side-channel attacks known as Differential Fault Analysis attacks, in which the error distribution is unknown. The method uses systematic nonlinear robust error detecting codes which distribute their error-detecting ability substantially uniformly across all possible errors. Error-detecting capabilities of these codes depend not just on error patterns (as in the case of linear codes) but also on data at the output of the device which is protected by the code and this data is unknown to the attacker since it depends on the secret key. The proposed nonlinear (n,k)-codes reduce the fraction of undetectable errors from 2^{-r} to 2^{-2r} as compared to the corresponding (n,k) linear code (where n−k=r and k>=r).

### CROSS REFERENCE TO RELATED APPLICATIONS

This application claims the benefit under 35 U.S.C. § 119(e) of the following U.S. provisional applications: (1) 60/694,606 filed Jun. 28, 2005, and (2) 60/694,607 filed Jun. 28, 2005, the contents and teachings of both of which are hereby incorporated by reference in their entirety.

### BACKGROUND

The disclosed methods and apparatus pertain to the field of error detection, specifically the detection of errors having an unknown or nonstationary probability distribution such as may occur in several contexts including a hardware-based attack on encryption/decryption circuitry.

Today's information security engineer is faced with the problem of building a trustworthy system from untrustworthy components. Security experts claim that the only workable solutions to date demand some minimal number of trustworthy components. These trustworthy components are relied on for ensuring overall system security by providing services such as authentication, encryption/decryption, cryptographic tokens and so on.

Traditional cryptographic protocol designs assume that input and output messages are available to attackers, but other information about the secret cryptographic keys is not available. However, recently a new class of attacks against cryptographic devices has become public. These attacks exploit easily accessible information such as power consumption, algorithm execution time, and input-output behavior under malfunctions, and can be mounted by anyone using low-cost equipment. Such attacks are referred to as side-channel attacks. They operate to amplify and evaluate leaked information with the help of statistical methods, and they are often much more powerful than classical cryptanalysis. Examples show that a very small amount of side-channel information is enough to completely break a cryptosystem. While many previously-known cryptanalytic attacks can be analyzed by studying algorithms, side-channel attack vulnerabilities result from electrical behavior of transistors and circuits of an implementation. Countermeasure considerations and strategies against such attacks include reducing variations and data dependencies in timing, power and radiation from the hardware, reduction of observability of system behavior after fault injection, and theoretical extension of the current mathematical models of cryptography to the physical setting which takes into consideration side-channel attacks.

A specific class of side-channel attacks are known as fault analysis attacks of which one of the most powerful are known as Differential Fault Analysis (DFA) attacks. DFA was first proposed in 1997 as an attack on the Data Encryption Standard (DES), and has since been applied to the more recent Advanced Encryption Standard (AES). DFA attacks are based on deriving information about the secret key by examining the differences between a cipher resulting from correct operation and a cipher of the same initial message resulting from faulty operation.

It has been suggested to employ concurrent error detection procedures as a hardware countermeasure against fault-injection-based cryptanalysis. For example, it has been proposed to add circuitry to perform decryption in parallel with encryption (with various possible levels of granularity) and compare the result with the input value to ensure that no error has occurred. These solutions have different detection time latencies and hardware costs and, in general, exhibit a large cost close to that of duplication either in space or in time and do not provide for a high level of security. Not all possible attacks have been taken into account. For example, it may have been assumed in such an approach that both encryption and decryption modules are not simultaneously under attack or faulty, an assumption that may not be very realistic for certain applications such as “smart card” applications.

Fault-detecting schemes have also been suggested for AES that are based on linear codes such as one-dimensional parity, Hamming, and Reed Solomon codes. These approaches based on linear error-detecting codes have non-uniform error detection. In a linear code, error patterns which are the same as a codeword are undetectable by the code. An undetectable error is such that the error cannot be detected if it distorts any valid codeword . This large class of errors in any linear code can be potentially used to attack a system, and a system using the linear codes would be unable to detect such an attack.

### SUMMARY

The present invention uses nonlinear systematic Robust (n,k) error-detecting code which reduces the number of undetectable errors and which have a uniform or almost uniform error detecting power against all errors. The encoding and decoding method and apparatus which is the subject of the present invention allow the construction of a systematic Robust code. The systematic nature of the method and apparatus refers to the separation of information and redundant bits, which one skilled in the art will appreciate allows for smaller, more efficient, and more flexible hardware implementations than if the methods and apparatus were not systematic. Previously suggested methods for encoding and decoding codes with uniform or almost uniform error-detecting power were non-systematic and the resulting codewords of the encoding method could not be partitioned into information and redundant bits. Hardware implementations of error-detecting schemes and protection against DFA attacks based on nonsystematic codes typically require very high overheads .

Methods and apparatus are disclosed that provide error detection that distributes error-detection power substantially uniformly among all possible errors, reducing or making no assumptions about any specific error distribution. The technique can be applied in a variety of environments having corresponding characteristics, for example in a system employing encryption/decryption and being subject to DFA or other forms of side-channel attacks. The technique can reduce the probability of undetected errors by a substantial margin over corresponding traditional error-detection-coding techniques, utilizing an amount of additional circuitry that will be acceptable for many applications.

The technique is based on a new class of robust, systematic codes and a corresponding robust protection scheme. Robustness is achieved using non-linear encoding functions, for example the inverse function 1/x or the cubic function x³ in the corresponding finite field. The codes resulting from these functions have the property that their error detection power is spread much more evenly among all possible errors, and they have fewer undetectable errors, than codes having the same number of redundancy bits but using linear encoding functions. For example, in the binary case, if the number of redundant bits added for protection is r and if all the information vectors and error patterns are equiprobable, then the probability of injecting an undetectable error if a device is protected by a disclosed robust code is 2^{-2r} versus 2^{-r} if the device were protected by a linear code having the same r (an error is undetectable by a nonlinear code if for any message (output of the device to be protected) from the code the corrupted message also belongs to the code; an error is represented by the binary vector such that its i-th component is equal to 1 if i-th bit of the original data is distorted).

A disclosed system includes a system element having a data input and a data output. The system element is a physical device and as such it is prone to faults and failures capable of causing errors to occur in the data output, such as in the case of a DFA attack on encryption/decryption circuitry where the faults and failures can be maliciously induced. The system further includes a check word generator to generate redundant bits of input data in such a way that an extended n=k+r bit input to the system element, is a codeword of a nonlinear systematic error detecting code sufficiently robust to provide substantially uniform protection against all non-zero errors that can occur in the output of the system element due to a fault. The system also includes error detection circuitry to verify that the n-bit output of the system element is a codeword of the selected code .

In an advantageous arrangement, the check word generator and the error detection circuitry each compute a non-linear function over the field of binary vectors. This non-linear function may for example be an inverse function or a cubic function in the corresponding field. More generally, the non-linear function may be selected from a class of functions known as “perfect” non-linear functions.

In an encryption system in which a DFA attack is detected, the encryption/decryption device may automatically disable itself, based on an assumption that the number of natural faults which can occur in a life span of a device is much less than the number of faulty ciphertexts needed for a realistic DFA attack. The disabling circuitry can include a simple counter which counts the number of errors detected. When a predetermined threshold is reached the device clears the secret key from its memory, thus preventing any further attacks. The threshold for the counter can be adjusted depending on the operating environment and expected life span of the device.

### BRIEF DESCRIPTION OF THE DRAWINGS

The foregoing and other objects, features and advantages will be apparent from the following description of particular embodiments, as illustrated in the accompanying drawing of which:

FIG. 1 is a block diagram of a system employing error detection coding as known in the art;

FIG. 2 is a block diagram of a smart card system employing data encryption as known in the art;

FIG. 3 is a block diagram depicting a type of attack that can be carried out against a smart card in an attempt to discover the value of an encryption key stored therein;

FIG. 4 is a block diagram of a system employing encryption with error-detection protection circuitry in accordance with the present invention; and

FIG. 5 is a block diagram of the error-detection protection circuitry of FIG. 4;

### DETAILED DESCRIPTION

FIG. 1 depicts the use of error detection as generally known in the art. Data labeled “Data In” 10 is processed in some fashion by a system element 12, and data obtained from the system element 12 is labeled “Data Out” 14. Both Data In 10 and Data Out 14 are shown as having k bits. The system element 12 may be any of a variety of functional components, including a communications channel, data storage (optical, magnetic, or semiconductor for example), or other data processing elements that may generate data errors. A check word generator 16 generates an r-bit check word 18 from the k-bit Data In 10. The check word 18 is combined with Data In 10 to form n-bit encoded data (n=k+r) that is provided to the system element 12. The n-bit output from the system element 12 is provided to an error detection circuit 20 that performs calculations according to the error detection coding scheme to determine whether any errors have occurred, and generates an error output (ERROR) 22 accordingly. Separate circuitry not shown in FIG. 1 is responsible for taking appropriate action if an error occurs. Based on the application, this action could include ignoring the error; logging the error; notifying a user of the error; or taking more drastic action such as disabling the system element 12 on the assumption that a further operation might cause system-level problems such as corruption of data, unsafe operation, breach of security, etc.

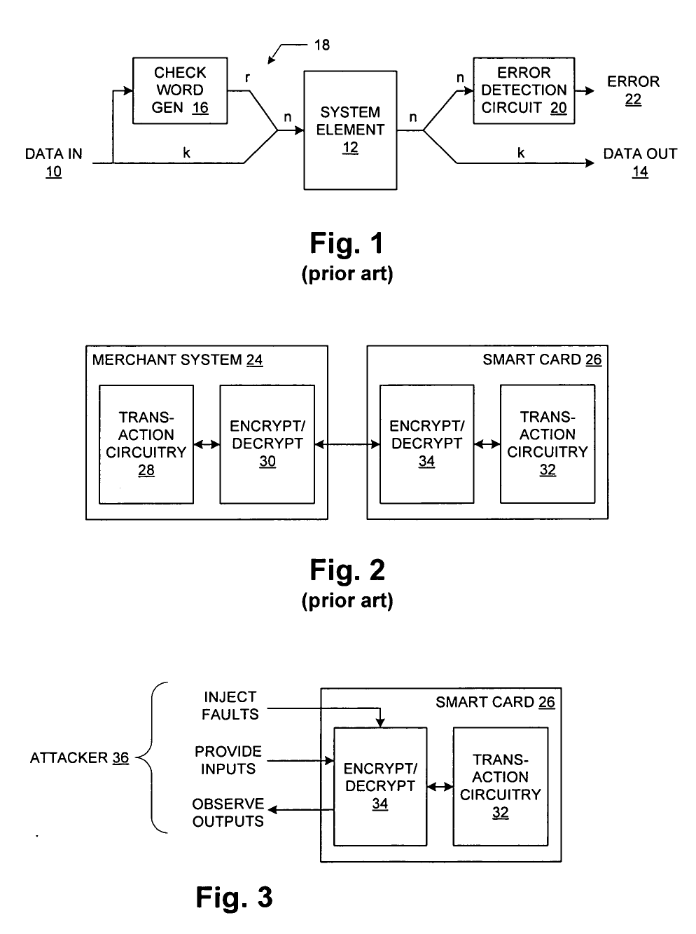

FIG. 2 shows a transaction processing system employing data security features as known in the art. In the simplified depiction of FIG. 2, the system include a merchant system 24 in communication with a so-called “smart card” 26, which is a portable card-like device that can be carried by a consumer for example and used to pay for purchased goods, among other things. In use, the smart card 26 is placed in or near a reader (not shown) in order to establish a communication channel with the merchant system 24, and various data is exchanged between the merchant system 24 and the smart card 26 to effect a desired transaction. The data may include, among other things, sensitive user and/or merchant data including financial account numbers, personal identity information, etc.

The merchant system 24 includes transaction circuitry 28 and encryption/decryption circuitry (ENCRYPT/DECRYPT) 30, and the smart card 26 likewise contains respective transaction circuitry 32 and encryption/decryption circuitry 34. In operation, the transaction circuitry 28 and transaction circuitry 32 generate data outputs in a so-called “cleartext” form, meaning the data as present at the respective inputs and outputs directly conveys the underlying information. If an account balance of $150.00 is to be conveyed between the two transaction circuitries 32 and 34, for example, such information is represented in part by a standard encoding of the value “150”. Thus an attacker having access to such cleartext data would be in a position to obtain a wealth of valuable information that can be used in various detrimental ways.

To help prevent an attacker from gaining such access, the encryption/decryption circuitries 30 and 34 are used to transfer the data between the merchant system 24 and smart card 26 in an encrypted or “ciphertext” form. An attacker having access to the channel between the merchant system 24 and smart card 26 observes only the encrypted data, and thus it is much more difficult for such an attacker to extract meaningful information. Various forms of encryption/decryption techniques may be used. Known techniques include the so-called Data Encryption Standard (DES) and the more recent Advanced Encryption Standard (AES).

While both the DES and AES techniques are very powerful encryption techniques that can provide a very high level of information security, as noted above they may be vulnerable to certain attacks such as the Differential Fault Analysis (DFA) form of side-channel attacks. FIG. 3 illustrates the approach. An attacker 36 injects faults into the encryption/decryption circuitry 34, and also provides known data input(s). The attacker 36 observes the data output(s) generated by the encryption/decryption circuitry 34 when operating under the conditions resulting from each of the injected faults. Generally, it is necessary for the attacker 36 to perform the procedure numerous times to obtain a corresponding number of samples, which are then used in an analysis procedure that, if successful, identifies the encryption key that is being utilized by the smart card 26. As discussed above, such attacks may be characterized by an almost complete lack of predictable information about the type of faults that are injected by the attacker. As this uncertainty translates into a corresponding uncertainty about the types of errors that might occur in the data, conventional error-detection approaches designed for specific classes of errors (such as independent errors in the binary symmetrical channels, burst errors, etc.) may be generally ineffective for detecting such attacks.

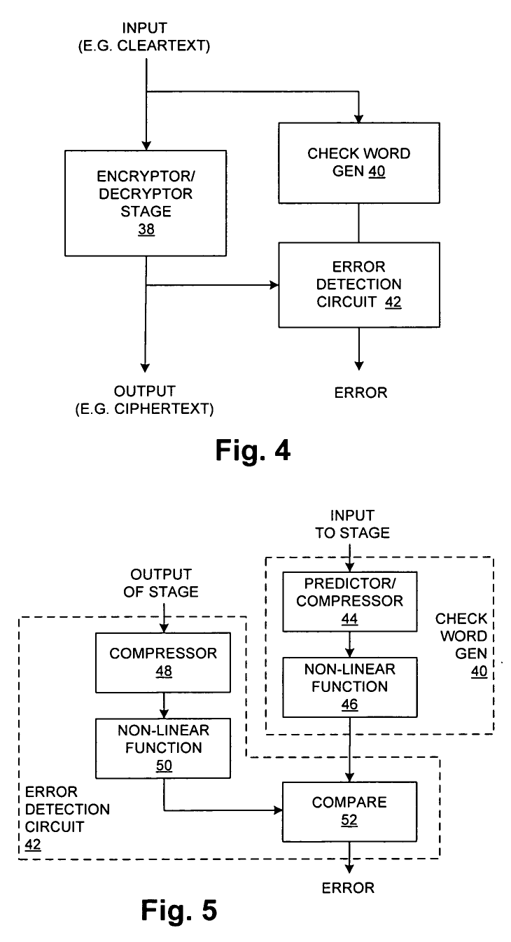

FIG. 4 illustrates an architecture that can be employed to combat attacks such as DFA attacks against systems employing encryption/decryption for data security. An encryption/decryption stage 38 having an input and an output is shown. In one embodiment, the encryption/decryption stage 38 may be a single “round” of an AES encryption or decryption operation. Alternatively, it may be the overall encryption or decryption operation, which in the case of AES can include multiple rounds. It will be appreciated that the input may be cleartext or an intermediate form of ciphertext, depending on the exact function being performed in the encryption/decryption stage 38. If the function is a first or only stage of encryption, then the input is generally in cleartext, whereas for decryption or a later stage of encryption, it is generally ciphertext. The output likewise may be cleartext or ciphertext. In the particular example of FIG. 4, the encryption/decryption stage 38 is performing encryption of a cleartext input into a ciphertext output.

The input data is provided to a check word generator 40. The output of the check word generator 40 is provided, along with the output from the encryption/decryption stage 38, to an error detection circuit 42. As described in more detail below, the check word generator 40 generates a check word that is a non-linear function of the output data (i.e., ciphertext), in particular a non-linear function that tends to have substantially uniform error-detection capability across all errors that might occur in the output from the encryption/decryption stage 38. The error detection circuitry calculates a check word from the output of the encryption/decryption stage 38 using the same non-linear function, and compares the generated check word with the check word provided by the check word generator 40. If the two check words do not match, it is an indication that an error has occurred. This error indication can be used in a variety of manners as discussed above. However, in the context of protecting against an attack against a smart card 26 or similar device containing an extremely sensitive cryptographic key, it may be prudent to take strong measures. Given the assumption that an attacker must perform a fairly large number of operations under different fault conditions to obtain enough information to derive the key, one measure may be to completely disable operation of the smart card 26 after a small number of errors have been detected. After this, , the cryptographic key can be erased from the smart card 26.

FIG. 5 shows the structure of the check word generator 40 and error detection circuitry 42. The check word generator 40 includes a predictor/compressor 44 followed by a non-linear function 46. The predictor/compressor 44 is utilized to generate an intermediate check word that is a linear (in the selected finite field) function of the output. Specifically, the intermediate check word is generally substantially smaller in size than the output. In the case of AES encryption, for example, the output is specified to be 128 bits in width. It is unwieldy and in many cases unnecessary to perform a non-linear function on such large data words. Greater simplicity and circuit efficiency is obtained by first reducing the input to words of a more tractable size, such as 32 bits. Specific examples of functions/circuitry that can be used within the predictor/compressor 44 to accomplish this reduction are shown below.

As indicated above, the non-linear function 46 operates on the check word from the predictor/compressor 44 to produce a check word that is a non-linear function of the output according to an error detection code that has its error-detection power distributed substantially uniformly among all possible errors. There are a variety of specific non-linear functions that can be used, including, for example, the inverse function 1/x and the cube function x³. Higher-power exponential functions may also be used. The cube function x³ may be a good choice for many application that utilize binary symbols, as it achieves a desired uniformity of error detection power among all errors while requiring less circuit area than higher-power functions. More generally, so-called “perfect” non-linear functions may be employed. Perfect non-linear functions have been utilized in the field of combinatorics and are characterized by flat auto-correlation characteristics. It should be noted that the operations performed in both the predictor/compressor 44 and error detection circuit 46 are finite-field operations.

The compressor 48 and non-linear function 50 of the error detection circuit 42 perform the same functions as their counterparts in the check word generator 40, i.e., the non-linear function 50 is the same as the non-linear function 46 and the compressor 48 is the same as the compressor portion of the predictor/compressor 44. It is unnecessary to repeat the predictor portion of the predictor/compressor 44 in the error detection circuit 42 because the function of the predictor portion is to operate on the input of the stage to generate an output that is linearly related to the output of the stage. In this sense, the predictor portion of the predictor compressor 44 mirrors that of the encryption/decryption stage 38. If the redundancy, and hence the size r of the check word (cubic signature if the selected non-linear function is x³), is chosen such that it is smaller than or equal to the output of the linear predictor r_{L}(r_{L}≦32), then the output of the linear predictor has to be first compressed before it is cubed. In the proposed design this is the role of the compressor portion of the predictor/compressor 44. This compressor may implement multiplication over the field of binary vectors by any (r_{L}×r) matrix with rank r.

In one variation of the embodiment of the invention suitable for error detection communication and data storage applications, the nonlinear function can be applied to the r-redundant bits of the codeword which are already a linear combination of the k information bits of the output of the original nonprotected device. That is, the corresponding checkword generator outputs a r-bit redundant output v which is related to the k-bit output w of the original device by the following function v=f(P*w) where P is a k by r matrix with rank k and * denotes multiplication over the field of binary vectors and f is a “perfect” nonlinear function over the respective r-bit field. An example of such a function is the inverse or a cubic function. If x is the input and function w=w(x) describe the behavior of the original non protected device, the linear transform P can be selected in such a way that v(x)=f(P*w(x)) will be very simple to minimize the hardware complexity (gate count, area) of the checkword generator.

In another variation of the embodiment of the invention suitable for error detection in communication and data storage application the nonlinear function can be applied directly to the k-bit information portion w. That is the corresponding checkword generator outputs a r-bit redundant output v which is related to the k-bit input of the checkword generator by the following function v=f(w) where f is a “perfect” nonlinear function which maps k-bit binary vectors to r-bit binary vectors. An example of such a function is known as the non-repetitive quadratic function (NRQF) f=_{w}·w₂⊕w₃w₄⊕ . . . ⊕ wᵢ₋₁w₁ where Wᵢ is the i-th r-bit subvector of length r of the k-information bits, · is multiplication over the respective r-bit field of binary vectors, and ⊕ is addition in the field. In such a variation the error detection circuit does not require a compressor and only needs a non-linear function prior to the comparison and has the property of having no undetectable errors.

Those skilled in the art will appreciate that while the encryptor/decryptor hardware and detection of fault attacks was used as the major example of the application of methods described herein the methods and apparatus are also applicable but are not limited to error detection in noncryptographic hardware, memory devices, and communication channels.

While this invention has been particularly shown and described with references to preferred embodiments thereof, it will be understood by those skilled in the art that various changes in form and details may be made therein without departing from the spirit and scope of the invention as defined by the appended claims.

What is claimed is:

1. A system, comprising:
a system element having a data input and a data output;
a check word generator operative to generate a first check word based on the data input, the first check word being generated according to a nonlinear systematic error detecting code sufficiently robust to provide substantially uniform protection against all non-zero errors that can occur in the data output due to faulty operation of the system element; and
error detection circuitry operative (1) to generate a second check word based on the data output, the second check word being generated according to the code, and (2) to compare the first check word to the second check word to determine whether a detectable error has occurred in the data output.

2. A system according to claim 1, wherein the check word generator and the error detection circuitry each employ a non-linear function to generate the respective first and second check words.

3. A system according to claim 2, wherein the non-linear function is an inverse function.

4. A system according to claim 2, wherein the non-linear function is a cubic function.

5. A system according to claim 2, wherein the non-linear function is a perfect non-linear function.

6. A system according to claim 1, wherein the system element comprises data encryption/decryption circuitry.

7. A data encryption device, comprising:
an encryption element operative to generate an encrypted data output by encrypting a data input according to a predetermined encryption algorithm and an encryption key;
a check word generator operative to generate a first check word based on the data input, the first check word being generated according to an error detecting code sufficiently robust to provide substantially uniform protection against all non-zero errors that can occur in the encrypted data output due to faulty operation of the encryption element; and
error detection circuitry operative (1) to generate a second check word based on the encrypted data output, the second check word being generated according to the error detecting code, and (2) to compare the first check word to the second check word to determine whether a detectable error has occurred in the encrypted data output.

8. A data encryption device according to claim 7, wherein the check word generator and the error detection circuitry each employ a non-linear function to generate the respective first and second check words.

9. A data encryption device according to claim 8, wherein the non-linear function is an inverse function.

10. A data encryption device according to claim 8, wherein the non-linear function is a cubic function.

11. A data encryption device according to claim 8, wherein the non-linear function is a perfect non-linear function.

12. A data encryption device according to claim 7, wherein:
the check word generator includes predictor circuitry operative according to a portion of the predetermined encryption algorithm to generate a value being a linear function of the encrypted data output; and
the first check word is generated based on the value generated by the predictor circuitry.

13. A data encryption device according to claim 7, wherein:
the check word generator includes compressor circuitry operative to generate a reduced-size value linearly related to the encrypted data output; and
the first check word is generated based on the value generated by the compressor circuitry.
